(19) United States
(12) Patent Application Publication
(10) Pub. No.: US 2024/0255356 A1
(43) Pub. Date: Aug. 1, 2024

(54) TEMPERATURE INFERENCE DEVICE AND CONVERTER SYSTEM

(71) Applicant: Fanuc Corporation, Minamitsuru-gun,Yamanashi (JP)

(72) Inventor: Wataru Kuroki, Minamitsuru-gun, Yamanashi (JP)

(73) Assignee: Fanuc Corporation, Minamitsuru-gun, Yamanashi (JP)

(21) Appl. No.: 18/289,270

(22) PCT Filed: May 19, 2021
(86) PCT No.: PCT/JP2021/019067

§ 371 Date: Nov. 2, 2023

(51) Int. Cl. G01K 7/00; G01K 1/024; G01K 3/00; H02H 7/12; H02M 5/458

(52) U.S. Cl. CPC G01K 7/00; G01K 1/024; G01K 3/005; H02M 5/4585; H02H 7/1216

(57) ABSTRACT

A temperature inference device according to the present invention calculates a junction temperature inference value of a power semiconductor device that is provided in a converter which performs power conversion between AC power of a three-phase AC power source side and DC power of a DC side. The temperature inference device includes an electric current detection unit that detects the value of an electric current flowing through the power semiconductor device; and a junction temperature inference unit that calculates a junction temperature inference value of the power semiconductor device on the basis of the unbalance rate of a three-phase AC power source which is connected to the converter and a provisional junction temperature value which has been calculated on the basis of at least the electric current value detected by the electric current detection unit.

### CROSS REFERENCE TO RELATED APPLICATIONS

This is the U.S. National Phase application of PCT/JP2021/019067, filed May 19, 2021, the disclosure of this application being incorporated herein by reference in its entirety for all purposes.

### FIELD OF THE INVENTION

The present invention relates to a temperature estimation device and a converter system.

### BACKGROUND OF THE INVENTION

A converter and an inverter are power conversion devices for performing conversion from direct-current power to alternating-current power or power conversion from alternating-current power to direct-current power. For example, in a motor drive device for driving motors in a machine tool, a forging machine, an injection molding machine, an industrial machine, or various types of robots, a converter converts alternating-current power supplied from an alternating-current power supply into direct-current power and outputs the converted power to a DC link, an inverter further converts the direct-current power in the DC link into alternating-current power and supplies the alternating-current power to a motor provided for each drive shaft as drive power. The DC link refers to a circuit part electrically connecting the direct-current output side of the converter to the direct-current input side of the inverter and may also be referred to as a “DC link unit,” a “direct-current link,” a “direct-current link unit,” a “direct-current intermediate circuit,” or the like.

When current flows through power semiconductor devices provided in a converter and an inverter, the converter and the inverter generate heat. In a PWM-controlled converter and a PWM-controlled inverter in particular, the temperature of a power semiconductor device rises by heat generation of the power semiconductor device due to a steady loss of the power semiconductor device, and a switching loss and a reverse recovery loss that are caused by switching operation of the power semiconductor device. The power semiconductor device in the converter or the inverter entering an overheated state due to the temperature of the power semiconductor device exceeding a rated temperature gives rise to damage to and a shortened life of the power semiconductor device. Therefore, it is required in operation of a converter and an inverter to recognize the temperature of a power semiconductor device or an area around the power semiconductor device as accurately as possible and protect the power semiconductor device from overheating.

Examples of a method for recognizing the temperature of a power semiconductor device or an area around the power semiconductor device in a converter and an inverter include a method of estimating the junction temperature of a power semiconductor device by calculation, a method of measuring the case temperature (the mold surface temperature and the base plate surface temperature) of a power semiconductor device, and a method of measuring the temperature of a radiator in contact with a power semiconductor device.

Among the aforementioned methods, the method of estimating the junction temperature of a power semiconductor device by calculation is a method of estimating the junction temperature being the temperature of a junction part of the power semiconductor device through computation processing by an arithmetic processing unit, based on a value of current flowing through the power semiconductor device and a thermal equivalent circuit.

For example, a motor controller including: a converter converting alternating-current voltage into direct-current voltage; an inverter converting the direct-current voltage into alternating-current voltage and driving a motor; a speed control unit generating a torque command, based on a speed command and motor speed; a torque control unit generating a PWM signal, based on the torque command and motor current, and driving an inverter; a current detection unit configured to detect the motor current; an inverter temperature detection unit detecting temperature of the inverter and generating an inverter temperature signal; and an overload protection unit generating a torque limit signal, based on a motor temperature signal, the inverter temperature signal, the motor current, and the motor speed, wherein the overload protection unit includes: a power element loss estimation unit generating an estimated power element loss of the inverter from the motor current; a junction temperature estimation unit configured to estimate junction temperature, based on the estimated power element loss and the inverter temperature; a motor loss estimation unit estimating a motor loss from the motor current and the motor speed; a coil temperature estimation unit estimating coil temperature from the estimated motor loss and the motor temperature signal; and an overload processing unit generating a torque limit signal or an alarm signal, based on the estimated junction temperature and the estimated coil temperature, is known (for example, see PTL 1).

For example, an elevator controller including: an inverter device drive-controlling an alternating-current motor operating an elevator cage in a vertical direction; a switching loss calculator calculating a momentary switching loss when switching is performed on a semiconductor power element in the inverter device; and a turn-on loss calculator calculating a momentary turn-on loss when the semiconductor power element is turned on and constant current flows, wherein a momentary junction temperature rise is estimated from the switching loss and the turn-on loss, and a load on the power element is reduced according to the junction temperature is known (for example, see PTL 2).

A power element overheating protection device being included in a drive device that drives a load by PWM control by using an inverter that converts direct current into desired alternating current, and providing protection against overheating of a plurality of power elements constituting the inverter, the power element overheating protection device including: a temperature detection means for detecting temperature of a case on which the plurality of power elements are mounted; a temperature estimation means for calculating an amount of increase in a temperature difference between junction temperature for the each power element and the case temperature, adding the case temperature to the acquired amount of increase in a temperature difference, and estimating junction temperature for the each power element, based on a result of calculation; an overheating abnormality determination means for comparing junction temperature for the each power element with allowable operating temperature for the each power element by calculation and when junction temperature is higher than allowable operating temperature according to a result of calculation, determining a power element to be in an overheated state and outputting an overheating abnormality signal; and a power cutoff signal output means for, when at least one overheating abnormality signal is input from the overheating abnormality determination means, outputting a power cutoff signal for cutting off a gate of the power element is known (for example, see PTL 3).

### PATENT LITERATURE

[PTL 1] JP2009-261078A
[PTL 2] JPH11(1999)-255442A
[PTL 3] JP2008-131722A

### SUMMARY OF THE INVENTION

In general, since an unbalance factor of voltage or current is low when a three-phase power supply connected to a converter is normal, variation in the junction temperature of each of a plurality of power semiconductor devices existing in the converter is small. Accordingly, even when the junction temperature of a power semiconductor device is estimated based on a single thermal equivalent circuit for the purpose of reducing the proportion of junction temperature estimation processing in arithmetic processing by an arithmetic processing unit (such as a CPU utilization rate), the deviation of a calculated estimated value of the junction temperature from the true value of the junction temperature of each power semiconductor device is small. Thus, when an unbalance factor of voltage or current of a three-phase power supply connected to a converter is low, reduction in a burden of the computation processing by the arithmetic processing unit and highly precise temperature estimation can coexist in the estimation processing of the junction temperature of a power semiconductor device based on a single thermal equivalent circuit.

However, since an unbalance factor of voltage or current increases when power quality of a three-phase power supply connected to a converter is poor or when an abnormality such as phase interruption occurs in the three-phase power supply, variation in the junction temperature of each of a plurality of power semiconductor devices existing in the converter also increases. When the junction temperature of a power semiconductor device is estimated based on a single thermal equivalent circuit in a situation in which an unbalance factor of the three-phase power supply is high, a calculated estimated value of the junction temperature greatly deviates from the true value of the junction temperature for some of the plurality of power semiconductor devices. In other words, a power semiconductor device with a true value of the junction temperature greatly deviating from a calculated estimated value of the junction temperature appears. Setting a thermal equivalent circuit for each of a plurality of power semiconductor devices and executing junction temperature estimation processing in order to accurately estimate the junction temperature of the power semiconductor device may be considered; however, in this case, the proportion of the junction temperature estimation processing in arithmetic processing by an arithmetic processing unit (such as a CPU utilization rate) may increase and affect arithmetic processing other than the junction temperature estimation processing. Further, while use of a high-performance arithmetic processing unit in order to suppress the effect on another type of arithmetic processing may be considered, such an arithmetic processing unit is expensive. Accordingly, there is a desire for provision of a temperature estimation device and a converter system including the same that enable high-precision calculation of an estimated junction temperature value of a power semiconductor device provided in a converter even when an unbalance factor of a three-phase power supply connected to the converter is high.

According to an aspect of the present disclosure, a temperature estimation device calculating an estimated junction temperature value of a power semiconductor device provided in a converter performing power conversion between alternating-current power on a three-phase power supply side and direct-current power on a direct current side includes: a current detection unit configured to detect a value of current flowing through the power semiconductor device; and a junction temperature estimation unit configured to calculate an estimated junction temperature value of the power semiconductor device, based on a provisional junction temperature value calculated based on at least a value of the current detected by the current detection unit, and an unbalance factor of the three-phase power supply connected to the converter.

Further, according to an aspect of the present disclosure, a converter system includes: the aforementioned temperature estimation device; and the converter being provided with the power semiconductor device and configured to perform power conversion between alternating-current power on a three-phase power supply side and direct-current power on a direct current side by on-off operation of the power semiconductor device, wherein the junction temperature estimation unit calculates an estimated junction temperature value of the power semiconductor device.

The aspects of the present disclosure enable provision of a temperature estimation device and a converter system including the same that enable high-precision calculation of an estimated junction temperature value of a power semiconductor device provided in a converter even when an unbalance factor of a three-phase power supply connected to the converter is high, such as when power quality of the three-phase power supply is poor or when an abnormality such as phase interruption occurs in the three-phase power supply. In other words, the aspects of the present disclosure enable reduction in the proportion of junction temperature estimation processing in arithmetic processing by an arithmetic processing unit (such as a CPU utilization rate) and therefore enable suppression of an effect on arithmetic processing other than the temperature estimation processing in the arithmetic processing unit.

### BRIEF DESCRIPTION OF DRAWINGS

FIG. 1 is a diagram illustrating a temperature estimation device according to a first embodiment and a fourth embodiment of the present disclosure and a converter system including the same.

FIG. 2 is a diagram illustrating a modified example of an unbalance factor calculation unit in the temperature estimation device according to the first embodiment of the present disclosure and the converter system including the same.

FIG. 3 is a diagram illustrating a relation between an unbalance factor α and a temperature compensation factor A, the relation being calculated by a second method for calculating a temperature compensation factor.

FIG. 4 is a flowchart illustrating an operation flow of the temperature estimation device according to the first embodiment of the present disclosure.

FIG. 5 is a diagram illustrating a temperature estimation device according to a second embodiment of the present disclosure and a converter system including the same.

FIG. 6 is a flowchart illustrating an operation flow of the temperature estimation device according to the second embodiment of the present disclosure.

FIG. 7 is a diagram illustrating a temperature estimation device according to a third embodiment of the present disclosure and a converter system including the same.

FIG. 8 is a flowchart illustrating an operation flow of a temperature estimation device according to the fourth embodiment of the present disclosure.

FIG. 9 is a flowchart illustrating an operation flow of the temperature estimation device according to the fourth embodiment of the present disclosure.

### DETAILED DESCRIPTION OF EMBODIMENTS OF THE INVENTION

A temperature estimation device and a converter system including the same will be described below with reference to drawings. For ease of understanding, the drawings use different scales as appropriate. Further, embodiments illustrated in the drawings are examples, and the device and the system are not limited to the illustrated embodiments.

Examples of a load of a converter system including a temperature estimation device according to an embodiment of the present disclosure on a direct current side include a group composed of an inverter and an alternating-current motor, and a direct-current motor. Examples of a machine provided with an alternating-current motor or a direct-current motor include a machine tool, a forging machine, an injection molding machine, an industrial machine, and various types of robots.

An example of an inverter and an alternating-current motor being provided as a load of a converter system including a temperature estimation device according to an embodiment of the present disclosure on the direct current side will be described below as an example. The type of alternating-current motor is not particularly limited and may be, for example, an induction motor or a synchronous motor. Further, the number of phases of the alternating-current motor does not particularly limit the embodiments of the present disclosure and may be, for example, three phases or a single phase. It should be noted that the following description is similarly applicable to a case of a direct-current motor being provided as a load of a converter system including a temperature estimation device according to an embodiment of the present disclosure on the direct current side.

First, a temperature estimation device according to a first embodiment of the present disclosure and a converter system including the same will be described.

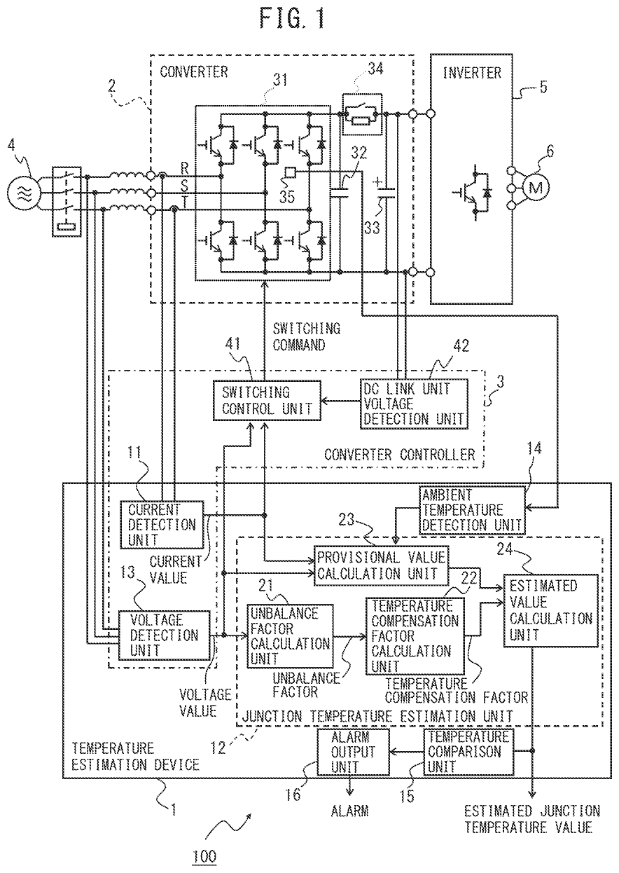

FIG. 1 is a diagram illustrating a temperature estimation device according to the first embodiment and a fourth embodiment of the present disclosure and a converter system including the same. A connection relation between components in the temperature estimation device and the converter system including the same that are illustrated in FIG. 1 is also applicable to the fourth embodiment to be described later.

A converter system 100 includes a temperature estimation device 1 according to the first embodiment of the present disclosure, a converter 2, and a converter controller 3. For example, a three-phase power supply 4 is connected to the alternating current side of the converter 2 through an electromagnetic contactor (MCC) and a three-phase reactor. Examples of the three-phase power supply 4 include a three-phase 400 V power supply, a three-phase 200 V power supply, and a three-phase 600 V power supply.

The converter 2 in the converter system 100 includes a three-phase bridge circuit 31, a smoothing capacitor 32, a DC link capacitor 33, a pre-charging circuit 34, and a temperature detection device 35.

The three-phase bridge circuit 31 in the converter 2 has only to be able to convert alternating-current power into direct-current power, and examples of the circuit include a PWM-switching-controlled rectifier circuit, a synchronous rectifier circuit, and a diode rectifier circuit. As an example, the three-phase bridge circuit 31 is assumed to be a PWM-switching-controlled rectifier circuit or a synchronous rectifier circuit in the example illustrated in FIG. 1.

The three-phase bridge circuit 31 includes three legs each related to each of three phases. Each leg includes an upper arm and a lower arm. When the converter 2 is configured with a PWM-switching-controlled rectifier circuit or a synchronous rectifier circuit, a power semiconductor device composed of a semiconductor switching device and a diode connected in anti-parallel with the semiconductor switching device is provided in each upper arm and each lower arm in the three-phase bridge circuit 31. Examples of the semiconductor switching device include an IGBT, an FET, a thyristor, a GTO, and a transistor. When the converter 2 is configured with a diode rectifier circuit, a power semiconductor device composed of a diode is provided in each upper arm and each lower arm in the three-phase bridge circuit 31.

The smoothing capacitor 32 is provided on the direct current side of the three-phase bridge circuit 31 and has a function of suppressing a pulsating component of a direct-current output from the three-phase bridge circuit 31. Examples of the smoothing capacitor 32 include an electrolytic capacitor and a film capacitor.

The DC link capacitor 33 is provided between the smoothing capacitor 32 and the direct current side of the inverter 5 and has a function of accumulating direct-current power. Examples of the DC link capacitor 33 include an electrolytic capacitor and a film capacitor.

The pre-charging circuit (initial charging circuit) 34 is provided in order to pre-charge (initially charge) the DC link capacitor 33 before the inverter 5 starts operation. The pre-charging circuit 34 includes a switch for opening and closing an electric path between the three-phase bridge circuit 31 and the DC link capacitor 33, and a charging resistor connected in parallel with the switch. The switch is open (turned off) during a pre-charging period from immediately after the start of the inverter 5 (immediately after power is turned on) until the start of normal operation of the inverter 5. Since the switch maintains the open state during the pre-charging period, current output from the three-phase bridge circuit 31 flows into the DC link capacitor 33 through the charging resistor as charging current, and the DC link capacitor 33 is charged (pre-charged). Since the current output from the three-phase bridge circuit 31 flows through the charging resistor during the pre-charging period, occurrence of rush current can be prevented. When the DC link capacitor 33 is charged to a predetermined voltage, the switch is switched from open to closed and completes the pre-charging by the pre-charging circuit 34. After completion of the pre-charging, the current output from the three-phase bridge circuit 31 flows toward the inverter 5 connected to the DC link, and the DC link capacitor 33 through the switch in the closed state.

The temperature detection device 35 is a device being provided close to a power semiconductor device and varying the output with a change in the temperature of the temperature detection device 35. A signal output from the temperature detection device 35 is sent to an ambient temperature detection unit 14 in the temperature estimation device 1 to be described later. Examples of the temperature detection device 35 include a PTC thermistor, an NTC thermistor, and a platinum resistance thermometer bulb.

The converter controller 3 in the converter system 100 includes a switching control unit 41 and a DC link unit voltage detection unit 42.

The DC link unit voltage detection unit 42 detects a DC link capacitor voltage value being the potential difference between both ends of the DC link capacitor 33. The capacitor voltage value corresponds to a direct-current link voltage value. In other words, a value of the potential difference between a positive potential appearing at a positive terminal of the three-phase bridge circuit 31 on the direct-current output side and a negative potential appearing at a negative terminal of the three-phase bridge circuit 31 on the direct-current output side is the DC link capacitor voltage value. The DC link capacitor voltage value detected by the DC link unit voltage detection unit 42 is sent to the switching control unit 41 and is also sent to a higher level controller (unillustrated) for controlling the inverter 5.

The switching control unit 41 generates a switching command for commanding a semiconductor switching device in each power semiconductor device in the three-phase bridge circuit 31 to switch on and off, based on a drive command received from the higher level controller (unillustrated), the DC link capacitor voltage value detected by the DC link unit voltage detection unit 42, a value of current input to the converter 2, the value being detected by a current detection unit 11 to be described later (a value of current flowing into a power semiconductor device), a value of the voltage between the terminals (i.e., inter-terminal voltage) of the converter 2 on the three-phase power supply side, the value being detected by a voltage detection unit 13 to be described later, and the like. The generated switching command is sent to a drive circuit (unillustrated) of the semiconductor switching device. The drive circuit applies gate voltage for turning the semiconductor switching device on or off to the semiconductor switching device in accordance with the content of the switching command.

It should be noted that the current detection unit 11 and the voltage detection unit 13 are shared between the temperature estimation device 1 and the converter controller 3 in the example illustrated in FIG. 1. As an alternative example, the temperature estimation device 1 and the converter controller 3 may be separately provided with a current detection unit and a voltage detection unit.

An arithmetic processing unit (processor) is provided in the converter controller 3. The arithmetic processing unit includes the aforementioned switching control unit 41 and the DC link unit voltage detection unit 42. For example, each unit included in the arithmetic processing unit is a function module provided by a computer program executed on the processor. For example, when the switching control unit 41 and the DC link unit voltage detection unit 42 are constructed in a computer program format, the function of each unit can be provided by operating the arithmetic processing unit in accordance with the computer program. The computer program for executing processing in each of the switching control unit 41 and the DC link unit voltage detection unit 42 may be provided in a form of being recorded on a computer-readable recording medium such as a semiconductor memory, a magnetic recording medium, or an optical recording medium. Alternatively, the switching control unit 41 and the DC link unit voltage detection unit 42 may be provided as a semiconductor integrated circuit in which the computer program providing the function of each unit is written.

The inverter 5 is connected to the direct current side of the converter 2. The inverter 5 is composed of a bridge circuit composed of a switching device and a diode connected in anti-parallel with the switching device. Examples of the switching device include an IGBT, an FET, a thyristor, a GTO, and a transistor but may include another semiconductor element. Since a motor 6 is assumed to be a three-phase alternating-current motor in the example illustrated in FIG. 1, the inverter 5 is configured with a three-phase bridge circuit. When the motor 6 is a single-phase motor, the inverter 5 is configured with a single-phase bridge circuit. By PWM control of on-off operation of an internal switching device based on a command from the higher level controller (unillustrated), the inverter 5 converts direct-current power in the DC link into alternating-current power and supplies the converted power to the motor 6 on the alternating current input-output side and also converts alternating-current power regenerated by deceleration of the motor 6 into direct-current power and returns the converted power to the DC link. The speed, the torque, or the rotor position of the motor 6 is controlled in accordance with alternating-current power supplied from the inverter 5. The higher level controller controlling the inverter 5 may be configured with a combination of an analog circuit and an arithmetic processing unit or may be configured with an arithmetic processing unit only. Examples of an arithmetic processing unit that may constitute the higher level controller controlling the inverter 5 include an IC, an LSI, a CPU, an MPU, and a DSP.

The temperature estimation device 1 according to the first embodiment of the present disclosure calculates an estimated junction temperature value of a power semiconductor device provided in the three-phase bridge circuit 31 in the converter 2. The temperature estimation device 1 includes the current detection unit 11, a junction temperature estimation unit 12, the voltage detection unit 13, the ambient temperature detection unit 14, a temperature comparison unit 15, and an alarm output unit 16.

The current detection unit 11 detects a value of current flowing through a power semiconductor device provided in the three-phase bridge circuit 31 in the converter 2 (a value of current input to the converter 2). The current value detected by the current detection unit 11 is sent to a provisional value calculation unit 23 in the junction temperature estimation unit 12 and the switching control unit 41 in the converter controller 3. It should be noted that the current detection unit 11 may also serve as a current detection unit provided in the converter controller 3.

The voltage detection unit 13 detects a value of the inter-terminal voltage (line voltage) of the converter 2 on the three-phase power supply 4 side. The inter-terminal voltage value detected by the voltage detection unit 13 is sent to the provisional value calculation unit 23 and an unbalance factor calculation unit 21 in the junction temperature estimation unit 12, and the switching control unit 41 in the converter controller 3. It should be noted that the voltage detection unit 13 may also serve as a voltage detection unit provided in the converter controller 3.

The ambient temperature detection unit 14 detects the ambient temperature of a power semiconductor device, based on a signal sent from the temperature detection device 35 provided close to the power semiconductor device. The ambient temperature of the power semiconductor device detected by the ambient temperature detection unit 14 is sent to the provisional value calculation unit 23 in the junction temperature estimation unit 12.

The junction temperature estimation unit 12 calculates an estimated junction temperature value of a power semiconductor device, based on a provisional junction temperature value calculated based on at least a current value detected by the current detection unit 11 and an unbalance factor of the three-phase power supply 4 connected to the converter 2. Thus, the junction temperature estimation unit 12 includes the unbalance factor calculation unit 21, a temperature compensation factor calculation unit 22, the provisional value calculation unit 23, and an estimated value calculation unit 24.

The provisional value calculation unit 23 calculates a provisional junction temperature value of a power semiconductor device, based on a current value detected by the current detection unit 11, an inter-terminal voltage value detected by the voltage detection unit 13, and the ambient temperature of the power semiconductor device detected by the ambient temperature detection unit 14. The provisional junction temperature value is a value of the junction temperature estimated in a balanced state of the three-phase power supply 4, i.e., a value estimated without consideration of an unbalance factor of the three-phase power supply 4.

A provisional junction temperature value Tⱼ₁ of a power semiconductor device can be expressed as Equation 1. In Equation 1, power generated by current flowing through the power semiconductor device is denoted by W. Further, in Equation 1, predefined unit reference power of the power semiconductor device is denoted by W₀, and a rate of temperature rise of the power semiconductor device per unit reference power W₀ is defined as “ΔT/W₀” (constant). Further, in Equation 1, the ambient temperature of the power semiconductor device detected by the ambient temperature detection unit 14 is denoted by Tₐ, a thermal time constant is denoted by τ, and a time during which power is generated in the power semiconductor device (a time during which current flows through the power semiconductor device) is denoted by t.

$$\begin{matrix}[ Math . 1 ] & \\ {T}_{j 1} = Δ T \times \frac{W}{{W}_{0}} \times ( 1 - {e}^{- \frac{t}{τ}} ) + {T}_{a} & ( 1 )\end{matrix}$$

In Equation 1, the power W generated in the power semiconductor device can be calculated by multiplying the square of the current value detected by the current detection unit 11 by the value of a resistance component of the power semiconductor device. For example, denoting the resistance of the power semiconductor device by R and the current flowing through the power semiconductor device by I, the power W generated in the power semiconductor device is “W=R×I².” Therefore, the provisional value calculation unit 23 calculates the provisional junction temperature value of the power semiconductor device in accordance with Equation 1, based on the current value detected by the current detection unit 11, the inter-terminal voltage value detected by the voltage detection unit 13, and the ambient temperature of the power semiconductor device detected by the ambient temperature detection unit 14. It should be noted that, for example, when the temperature of an installation location of the converter 2 is nearly constant, the ambient temperature detection unit 14 and the temperature detection device 35 may be omitted by setting the ambient temperature Tₐ of the power semiconductor device to a constant (i.e., the temperature of the installation location of the converter 2) in Equation 1.

The unbalance factor calculation unit 21 calculates an unbalance factor of the three-phase power supply 4. In the example illustrated in FIG. 1, the unbalance factor calculation unit 21 calculates an unbalance factor of voltage of the three-phase power supply 4, based on a value of the inter-terminal voltage (line voltage) detected by the voltage detection unit 13.

The unbalance factor of voltage of the three-phase power supply 4 can be calculated in accordance with a generally known equation. Two examples of a method for calculating an unbalance factor of voltage of the three-phase power supply 4 will be described. The source of the two calculation methods is the home page of Japan Electric Engineers' Association Public Service Corporation (https://jeea.or.jp/course/contents/05102/).

Description of a first method for calculating an unbalance factor of voltage of the three-phase power supply 4 is as follows.

Denoting values of the inter-terminal voltage (line voltage) in three phases RST detected by the voltage detection unit 13 by ERS, EST, and ETR, an average inter-terminal voltage value E_{avg} can be expressed as Equation 2.

$$\begin{matrix}[ Math . 2 ] & \\ {E}_{avg} = \frac{{E}_{RS} + {E}_{ST} + {E}_{TR}}{2} & ( 2 )\end{matrix}$$

A positive-phase voltage E₁ can be expressed as Equation 3.

$$[ Math . 3 ]$$

$$( 3 )$$

$${E}_{1} = \sqrt{\frac{{E}_{RS}^{2} + {E}_{ST}^{2} + {E}_{TR}^{2}}{6} + \frac{\sqrt{{E}_{avg} ( {E}_{avg} - {E}_{RS} ) ( {E}_{avg} - {E}_{ST} ) ( {E}_{avg} - {E}_{TR} )}}{\sqrt{3}}}$$

A negative-phase voltage E₂ can be expressed as Equation 4.

$$[ Math . 4 ]$$

$$( 4 )$$

$${E}_{2} = \sqrt{\frac{{E}_{RS}^{2} + {E}_{ST}^{2} + {E}_{TR}^{2}}{6} - \frac{2 \sqrt{{E}_{avg} ( {E}_{avg} - {E}_{RS} ) ( {E}_{avg} - {E}_{ST} ) ( {E}_{avg} - {E}_{TR} )}}{\sqrt{3}}}$$

Therefore, according to the first method for calculating an unbalance factor of voltage of the three-phase power supply 4, the unbalance factor k of the voltage of the three-phase power supply 4 can be expressed as Equation 5 by using the positive-phase voltage E₁ indicated in Equation 3 and the negative-phase voltage E₂ indicated in Equation 4.

$$[ Math . 5 ]$$

$$k = \frac{{E}_{2}}{{E}_{1}} \times 100 [ \% ] \qquad ( 5 )$$

Description of a second method for calculating an unbalance factor of voltage of the three-phase power supply 4 is as follows.

Denoting values of the inter-terminal voltage (line voltage) in three phases RST detected by the voltage detection unit 13 by ERS, EST, and ETR, an average inter-terminal voltage value E_{avg} can be expressed as aforementioned Equation 2. At this time, the maximum absolute value E_{diffmax} of the differences between each value of the inter-terminal voltages ERS, EST, and ETR, and the average inter-terminal voltage value E_{avg} can be expressed as Equation 6.

$$[ Math . 6 ]$$

$${E}_{diffmax} = max \{ \vert {E}_{RS} - {E}_{avg} \vert , \vert {E}_{ST} - {E}_{avg} \vert , \vert {E}_{TR} - {E}_{avg} \vert \} \qquad ( 6 )$$

Therefore, according to the second method for calculating an unbalance factor of voltage of the three-phase power supply 4, the unbalance factor k of the voltage of the three-phase power supply 4 can be expressed as Equation 7 by using the average inter-terminal voltage value E_{avg} indicated in Equation 2 and E_{diffmax} indicated in Equation 6.

$$[ Math . 7 ]$$

$$k = \frac{{E}_{diffmax}}{{E}_{avg}} \times 100 [ \% ] \qquad ( 7 )$$

For example, the unbalance factor calculation unit 21 calculates an unbalance factor of voltage of the three-phase power supply 4 in accordance with aforementioned Equation 5 or Equation 7, based on the value of the inter-terminal voltage detected by the voltage detection unit 13.

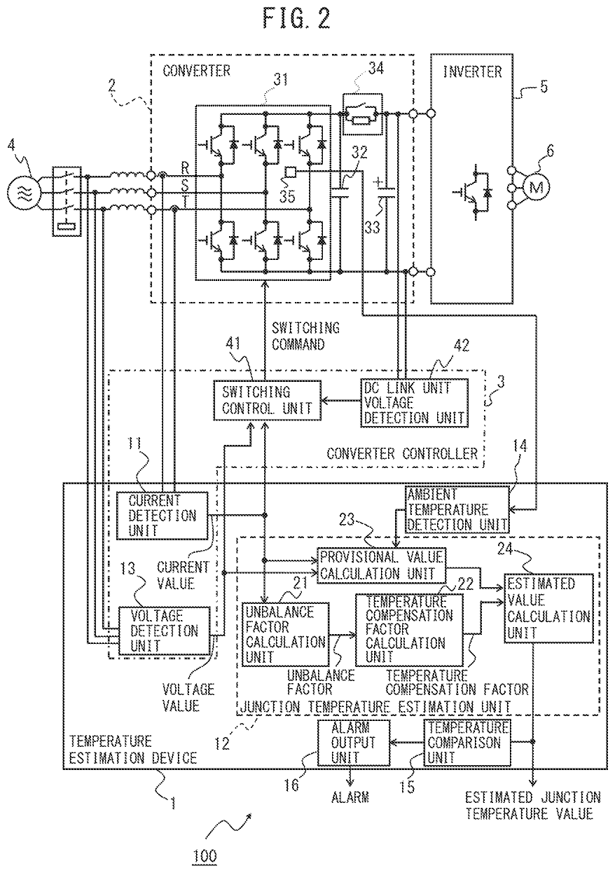

It should be noted that, as an unbalance factor of the three-phase power supply 4, the unbalance factor calculation unit 21 may calculate an unbalance factor of current of the three-phase power supply 4, based on a current value detected by the current detection unit 11 (a value of current input to the converter 2). FIG. 2 is a diagram illustrating a modified example of the unbalance factor calculation unit in the temperature estimation device according to the first embodiment of the present disclosure and the converter system including the same. The current value detected by the current detection unit 11 is sent to the unbalance factor calculation unit 21. The unbalance factor calculation unit 21 calculates an unbalance factor of current of the three-phase power supply 4, based on the current value detected by the current detection unit 11. In calculation of an unbalance factor of current of the three-phase power supply 4, for example, an equation acquired by replacing “voltage value” with “current value” in aforementioned Equation 5 or Equation 7 may be used. Since circuit components other than the unbalance factor calculation unit 21 in FIG. 2 are similar to the circuit components illustrated in FIG. 1, the same circuit components are given the same sign, and detailed description of the circuit component is omitted.

An unbalance factor of the three-phase power supply 4 calculated by the unbalance factor calculation unit 21 is sent to the temperature compensation factor calculation unit 22. The temperature compensation factor calculation unit 22 calculates a temperature compensation factor, based on the unbalance factor. The temperature compensation factor calculated by the temperature compensation factor calculation unit 22 is sent to the estimated value calculation unit 24. As an estimated junction temperature value of the power semiconductor device, the estimated value calculation unit 24 outputs a value acquired by multiplying a provisional junction temperature value by the temperature compensation factor.

A provisional junction temperature value, a temperature compensation factor, and an estimated junction temperature value will be described in more detail.

As described above, a provisional junction temperature value calculated by the provisional value calculation unit 23 in accordance with Equation 1 is a value of the junction temperature estimated in a situation in which the three-phase power supply 4 is balanced (not unbalanced). The provisional junction temperature value calculated in accordance with Equation 1, based on a current value detected by the current detection unit 11 and a voltage value detected by the voltage detection unit 13 in the situation in which the three-phase power supply 4 is balanced (not unbalanced) is a value close to the true value of the junction temperature, and therefore even when the provisional junction temperature value is estimated as-is to be the junction temperature of the power semiconductor device (i.e., used as an estimated junction temperature value), an error is small.

However, a provisional junction temperature value calculated in accordance with Equation 1, based on a current value detected by the current detection unit 11 and a voltage value detected by the voltage detection unit 13 in a situation in which an unbalance factor of the three-phase power supply 4 is high greatly deviates from the true value of the junction temperature for some of a plurality of power semiconductor devices. Then, according to the first embodiment of the present disclosure, a temperature compensation factor reflecting an unbalance factor of the three-phase power supply 4 is calculated as a parameter for reducing a deviation of a provisional junction temperature value calculated by the provisional value calculation unit 23 in the situation in which an unbalance factor of the three-phase power supply 4 is high from the true value of the junction temperature, and a value acquired by multiplying the provisional junction temperature value by the temperature compensation factor is determined to be an estimated junction temperature value of the power semiconductor device.

Two examples of a method for calculating a temperature compensation factor will be described.

Description of the first method for calculating a temperature compensation factor is as follows.

For example, an unbalance factor k is calculated by the aforementioned second method for calculating an unbalance factor of voltage of the three-phase power supply 4. At this time, assuming that the minimum inter-terminal voltage value among ERS, EST, and ETR is ERS in Equation 6, Equation 8 holds.

$$[ Math . 8 ]$$

$${E}_{diffmax} = \vert {E}_{RS} - {E}_{avg} \vert = {E}_{avg} - {E}_{RS} \qquad ( 8 )$$

Equation 9 is acquired by modifying Equation 8 by using Equation 7.

$$[ Math . 9 ]$$

$${E}_{RS} = {E}_{avg} - {E}_{diffmax} = {E}_{avg} - ( \frac{k}{100} ) \times {E}_{avg} = ( \frac{100 - k}{100} ) \times {E}_{avg} \qquad ( 9 )$$

Power W_{RS} generated in a power semiconductor device in the R-phase or the S-phase when voltage of the three-phase power supply 4 is unbalanced and the voltage ERS is applied between the R-phase and the S-phase can be expressed as Equation 10.

$$[ Math . 10 ]$$

$${W}_{RS} = \frac{{E}_{RS}^{2}}{R} = {( \frac{100 - k}{100} )}^{2} \times \frac{1}{R} \times {E}_{avg}^{2} \qquad ( 10 )$$

On the other hand, power W_{RS} generated in the power semiconductor device in the R-phase or the S-phase when voltage of the three-phase power supply 4 is balanced and the voltage ERS is applied between the R-phase and the S-phase can be expressed as Equation 11.

$$[ Math . 11 ]$$

$${W}_{RS} = \frac{{E}_{RS}^{2}}{R} = \frac{{E}_{avg}^{2}}{R} \qquad ( 11 )$$

It is understood that multiplying the power W_{RS} when voltage of the three-phase power supply 4 is balanced, the power being indicated in Equation 11, by a coefficient A indicated in Equation 12 yields the power W_{RS} when voltage of the three-phase power supply 4 is unbalanced, the power being indicated in Equation 10.

$$[ Math . 12 ]$$

$$A = {( \frac{100}{100 - k} )}^{2} \qquad ( 12 )$$

The coefficient A indicated in Equation 12 is used as a temperature compensation factor for decreasing the deviation of a provisional junction temperature value calculated by the provisional value calculation unit 23 in the situation in which an unbalance factor of the three-phase power supply 4 is high from the true value of the junction temperature. For example, when the unbalance factor k is 0%, the temperature compensation factor A is 1. The temperature compensation factor calculation unit 22 calculates the temperature compensation factor A in accordance with Equation 12 by using the unbalance factor k calculated by the unbalance factor calculation unit 21 and sends the temperature compensation factor A to the estimated value calculation unit 24. For example, as an estimated junction temperature value of the power semiconductor device, the estimated value calculation unit 24 outputs a value acquired by multiplying a provisional junction temperature value expressed by Equation 1 by the temperature compensation factor A calculated by the temperature compensation factor calculation unit 22.

Description of a second method for calculating a temperature compensation factor is as follows.

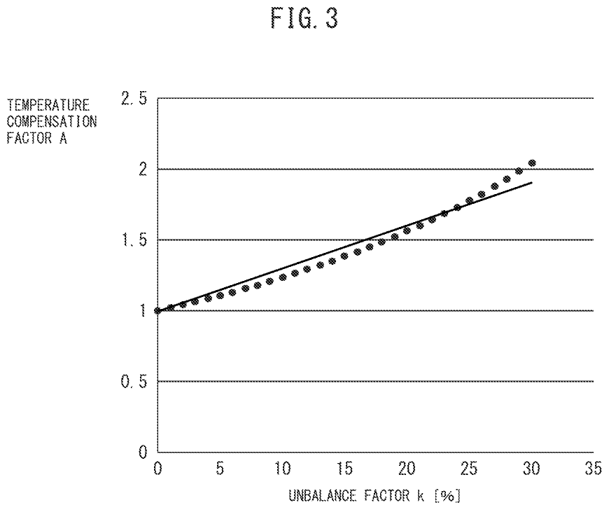

The second method for calculating a temperature compensation factor is a method of finding a relational expression between an unbalance factor and a temperature compensation factor by operating the converter system 100 connected to an experimental three-phase power supply that can output line voltage with any unbalance factor varying from 0% to 100% through an experiment performed before actual operation of the converter system 100. In the experiment, the junction temperature of each power semiconductor device in the three-phase bridge circuit 31 is measured while causing the experimental three-phase power supply to output line voltage with a specific unbalance factor in the range from 0% to 100%, and a temperature compensation factor A for the specific unbalance factor is calculated by dividing the maximum value of the measured junction temperature by an estimated junction temperature value indicated in Equation 1. FIG. 3 is a diagram illustrating a relation between an unbalance factor k and a temperature compensation factor A, the relation being calculated by the second method for calculating a temperature compensation factor. Temperature compensation factors A related to unbalance factors k varying from 0% to 30% acquired through the experiment are indicated by black circles in FIG. 3. An approximation expression indicating a relation between an unbalance factor k and a temperature compensation factor A is calculated from values of the unbalance factor k and the temperature compensation factor A that are acquired through the experiment. While a relation between an unbalance factor k and a temperature compensation factor A is calculated by a linear approximation (linear function) as an example in FIG. 3, a function other than a linear function may be used as an approximation expression. Further, an approximation expression indicating a relation between an unbalance factor k and a temperature compensation factor A with unbalance factors varying from 0% to 100% as one interval may be calculated. Alternatively, unbalance factors varying from 0% to 100% may be divided into a plurality of intervals, and an approximation expression indicating a relation between an unbalance factor k and a temperature compensation factor A may be calculated for each interval. An approximation expression indicating a relation between an unbalance factor k and a temperature compensation factor A found through the experiment is previously stored in the temperature compensation factor calculation unit 22. The temperature compensation factor calculation unit 22 calculates, in accordance with the approximation expression, a temperature compensation factor A related to an unbalance factor k calculated by the unbalance factor calculation unit 21 and sends the temperature compensation factor A to the estimated value calculation unit 24. For example, as an estimated junction temperature value of the power semiconductor device, the estimated value calculation unit 24 outputs a value acquired by multiplying a provisional junction temperature value expressed by Equation 1 by the temperature compensation factor A calculated by the temperature compensation factor calculation unit 22.

Thus, an estimated junction temperature value of a power semiconductor device is acquired by multiplying a provisional junction temperature value expressed by Equation 1 by a temperature compensation factor A calculated by the temperature compensation factor calculation unit 22. In other words, an estimated junction temperature value Tⱼ₂ of a power semiconductor device can be expressed as Equation 13.

$$[ Math . 13 ]$$

$${T}_{j 2} = A \times Δ T \times \frac{W}{{W}_{0}} \times ( 1 - {e}^{- \frac{t}{τ}} ) + {T}_{a} \qquad ( 13 )$$

It should be noted that when a provisional junction temperature value is calculated in accordance with Equation 1, power W generated in a power semiconductor device is calculated by multiplying a value acquired by squaring a current value detected by the current detection unit 11 by the value of a resistance component of the power semiconductor device. As an alternative method, the power W may be calculated by multiplying the forward voltage V_{f} or the collector-emitter saturation voltage V_{CE}(sat) of the power semiconductor by the current value detected by the current detection unit 11. Denoting resistance of the power semiconductor device by R and current flowing through the power semiconductor device by I, the power W generated in the power semiconductor device is “W=R×I²,” and therefore Equation 1 can be modified as Equation 14.

$$[ Math . 14 ]$$

$${T}_{j 1} = Δ T \times \frac{R}{{W}_{0}} \times {I}^{2} \times ( 1 - {e}^{- \frac{t}{τ}} ) + {T}_{a} \qquad ( 14 )$$

In Equation 14, a rate of temperature rise ΔT, the resistance R of the power semiconductor device, and the reference power W₀ of the power semiconductor device are assumed to be constant values for simplification of calculation, and a constant M expressed by Equation 15 is introduced.

$$[ Math . 15 ]$$

$$M = Δ T \times \frac{R}{{W}_{0}} \qquad ( 15 )$$

Substitution of Equation 15 into Equation 14 yields a provisional junction temperature value Tⱼ₁ expressed by Equation 16.

$$[ Math . 16 ]$$

$${T}_{j 1} = M \times {I}^{2} \times ( 1 - {e}^{- \frac{t}{τ}} ) + {T}_{a} \qquad ( 16 )$$

The provisional value calculation unit 23 can calculate a provisional junction temperature value of a power semiconductor device in accordance with Equation 16, based on a current value detected by the current detection unit 11 and the ambient temperature of the power semiconductor device detected by the ambient temperature detection unit 14. Therefore, an estimated junction temperature value Tⱼ₂ can be expressed as Equation 17.

$$[ Math . 17 ]$$

$${T}_{j 2} = A \times M \times {I}^{2} \times ( 1 - {e}^{- \frac{t}{τ}} ) + {T}_{a} \qquad ( 17 )$$

For example, an estimated junction temperature value calculated by the estimated value calculation unit 24 as described above is displayed on a display unit (unillustrated). Examples of the display unit include a single display device, a display device attached to a higher level controller, a display device attached to the temperature estimation device 1, a display device attached to the converter system 100, a display device attached to a motor drive device including the converter system 100, and display devices attached to a personal computer and a mobile terminal. Alternatively, an estimated junction temperature value calculated by the temperature estimation device 1 may be output by voice by audio equipment (unillustrated) instead of being output by a display unit. Thus, an operator can accurately recognize an estimated junction temperature value of a power semiconductor device even when an unbalance factor of the three-phase power supply 4 is high, such as when power quality of the three-phase power supply 4 is poor or when an abnormality such as phase interruption occurs in the three-phase power supply 4.

Further, an estimated junction temperature value calculated by the estimated value calculation unit 24 as described above is sent to the temperature comparison unit 15.

The temperature comparison unit 15 compares an estimated junction temperature value calculated by the estimated value calculation unit 24 in the junction temperature estimation unit 12 with a predetermined temperature threshold value. The comparison result by the temperature comparison unit 15 is sent to the alarm output unit 16. For example, the temperature threshold value may be set to a temperature lower than a temperature at which a power semiconductor device is destroyed due to overheating by about several tens of percents, a temperature lower than a temperature at which the converter system 100 is destroyed due to overheating of a power semiconductor device by about several tens of percents, or a temperature higher than a rated temperature predefined for a power semiconductor device or the converter system by about several tens of percents. The numerical values mentioned here are strictly examples, and the temperature threshold value may take on a different numerical value. Further, for example, the temperature threshold value may be set after finding a relationship with an application environment of the converter system 100 and existence of an alarm output by the alarm output unit 16, or the like in advance by operating the converter system 100 experimentally or through actual operation, or by a computer simulation. The set temperature threshold value is stored in a storage unit (unillustrated). It should be noted that by configuring the storage unit (unillustrated) storing the temperature threshold value rewritable by external equipment, the temperature threshold value can be changed to a suitable value as needed even after being temporarily set.

When a comparison result by the temperature comparison unit 15 indicates that an estimated junction temperature value is equal to or greater than the temperature threshold value, the alarm output unit 16 outputs an alarm. For example, the alarm output from the alarm output unit 16 is sent to a display unit (unillustrated), and for example, the display unit performs a display for notifying an operator of “overheating of a power semiconductor device.” Examples of the display unit include a single display device, a display device attached to a higher level controller, a display device attached to the temperature estimation device 1, a display device attached to the converter system 100, a display device attached to a motor drive device including the converter system 100, and display devices attached to a personal computer and a mobile terminal. Alternatively, for example, the alarm output from the alarm output unit 16 is sent to audio equipment (unillustrated). Further, for example, the alarm output from the alarm output unit 16 is sent to light-emitting equipment (unillustrated) such as an LED or a lamp, and by emitting light when receiving the alarm, the light-emitting equipment notifies an operator of “overheating of a power semiconductor device.” Further, for example, the alarm output from the alarm output unit 16 is sent to audio equipment (unillustrated), and for example, by producing a sound such as a voice, a speaker, a buzzer, or a chime when receiving an alarm, the audio equipment notifies the operator of “overheating of a power semiconductor device.” Thus, the operator can reliably and easily recognize overheating of a power semiconductor device. For example, the operator can easily take measures such as shutting down the converter system 100 due to an emergency or replacing a power semiconductor device. Further, the alarm output from the alarm output unit 16 may be used for protective operation of the converter system 100 or may be used for protective operation of a motor drive device including the converter system 100.

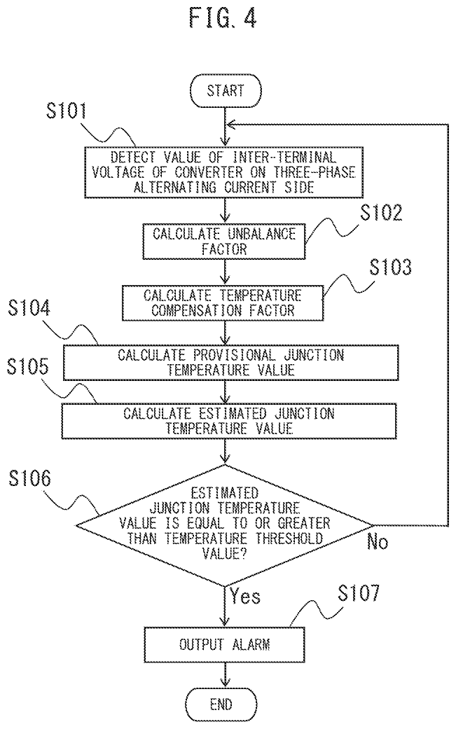

FIG. 4 is a flowchart illustrating an operation flow of the temperature estimation device according to the first embodiment of the present disclosure.

Temperature estimation processing of a power semiconductor device by the temperature estimation device 1 according to the first embodiment of the present disclosure and the converter system 100 including the same is periodically executed when the converter system 100 is connected to the three-phase power supply 4 and is actually in operation.

In step S101, the voltage detection unit 13 detects a value of the inter-terminal voltage of the converter 2 on the three-phase power supply 4 side. Further, while illustration is omitted in FIG. 4, the current detection unit 11 detects a value of current flowing through a power semiconductor device provided in the three-phase bridge circuit 31 in the converter 2 (a value of current input to the converter 2), and the ambient temperature detection unit 14 detects the ambient temperature of the power semiconductor device, based on a signal sent from the temperature detection device 35.

In step S102, the unbalance factor calculation unit 21 calculates an unbalance factor of the three-phase power supply 4. The calculated unbalance factor of the three-phase power supply 4 may be an unbalance factor of voltage or an unbalance factor of current.

In step S103, the temperature compensation factor calculation unit 22 calculates a temperature compensation factor by using the unbalance factor calculated by the unbalance factor calculation unit 21.

In step S104, the provisional value calculation unit 23 calculates a provisional junction temperature value of the power semiconductor device, based on the current value detected by the current detection unit 11, the inter-terminal voltage value detected by the voltage detection unit 13, and the ambient temperature of the power semiconductor device detected by the ambient temperature detection unit 14.

In step S105, as an estimated junction temperature value of the power semiconductor device, the estimated value calculation unit 24 outputs a value acquired by multiplying the provisional junction temperature value calculated by the provisional value calculation unit 23 by the temperature compensation factor calculated by the temperature compensation factor calculation unit 22. The estimated junction temperature value calculated by the estimated value calculation unit 24 is sent to the temperature comparison unit 15. Further, for example, the estimated junction temperature value calculated by the estimated value calculation unit 24 may be displayed on a display unit (unillustrated) or be output by voice by audio equipment (unillustrated).

In step S106, the temperature comparison unit 15 compares the estimated junction temperature value calculated by the estimated value calculation unit 24 in the junction temperature estimation unit 12 with a predetermined temperature threshold value. In step S106, the processing advances to step S107 when the estimated junction temperature value is determined to be equal to or greater than the temperature threshold value and returns to step S101 when the estimated junction temperature value is determined to be less than the temperature threshold value.

In step S107, the alarm output unit 16 outputs an alarm.

The processing in steps S101 to S107 described above is periodically and repeatedly executed until an alarm is output by the alarm output unit 16 in step S107.

Next, a temperature estimation device according to a second embodiment of the present disclosure and a converter system including the same will be described.

The second embodiment of the present disclosure switches between outputting a value acquired by multiplying a provisional junction temperature value by a temperature compensation factor as an estimated junction temperature value and outputting the provisional junction temperature value as-is as an estimated junction temperature value, depending on the magnitude of current flowing through a power semiconductor device.

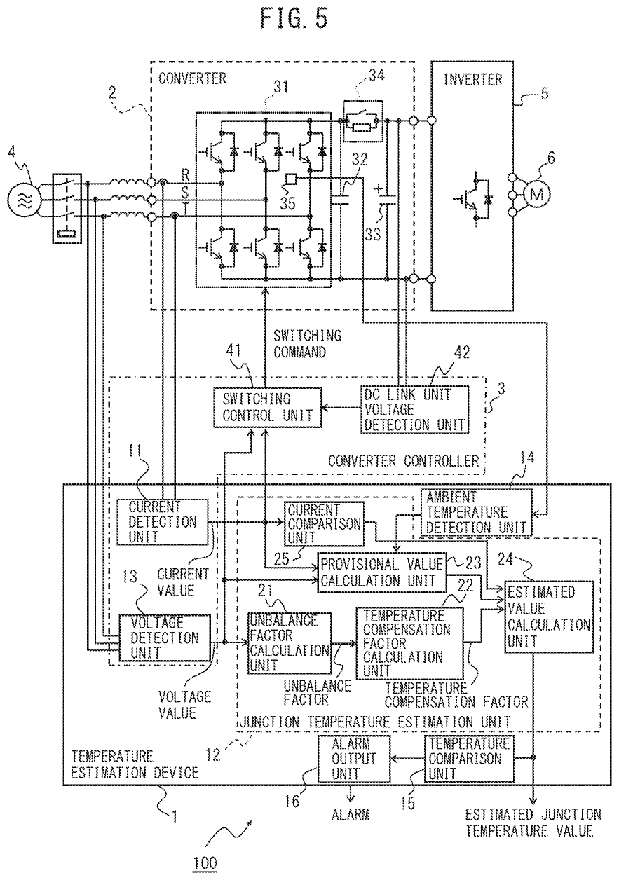

FIG. 5 is a diagram illustrating a temperature estimation device according to the second embodiment of the present disclosure and a converter system including the same.

A temperature estimation device 1 according to the second embodiment of the present disclosure is acquired by adding a current comparison unit 25 to the junction temperature estimation unit 12 in the temperature estimation device 1 according to the first embodiment illustrated in FIG. 1 or FIG. 2. In other words, a junction temperature estimation unit 12 further includes the current comparison unit 25.

A current value detected by the current detection unit 11 is also sent to the current comparison unit 25 in addition to a provisional value calculation unit 23 in the junction temperature estimation unit 12 and a switching control unit 41 in a converter controller 3.

The current comparison unit 25 compares a current value detected by the current detection unit 11 with a predetermined current threshold value. The comparison result by the current comparison unit 25 is sent to an estimated value calculation unit 24. For example, the current threshold value is set to 60% of a rated current of a power semiconductor device, but the numerical value mentioned here is strictly an example, and the current threshold value may take on a different numerical value. Further, for example, the current threshold value may be set after finding a relationship with an application environment of a converter system 100 and existence of an alarm output by an alarm output unit 16, or the like in advance by operating the converter system 100 experimentally or through actual operation, or by a computer simulation. The set current threshold value is stored in a storage unit (unillustrated). It should be noted that by configuring the storage unit (unillustrated) storing the current threshold value rewritable by external equipment, the current threshold value can be changed to a suitable value as needed even after being temporarily set.

When current flowing through a power semiconductor device is low, an effect of an unbalance factor of a three-phase power supply 4 is small, and therefore a provisional junction temperature value calculated by the provisional value calculation unit 23 is considered close to the true value. Then, according to the second embodiment of the present disclosure, when current flowing through a power semiconductor device is low, a computation load of an arithmetic processing unit constituting an unbalance factor calculation unit 21 and a temperature compensation factor calculation unit 22 is reduced by not operating the unbalance factor calculation unit 21 and the temperature compensation factor calculation unit 22 and determining a provisional junction temperature value as a junction temperature estimation unit. On the other hand, when the current flowing through a power semiconductor device is high, an effect of an unbalance factor of the three-phase power supply 4 is large, and therefore a provisional junction temperature value calculated by the provisional value calculation unit 23 is considered to greatly deviate from the true value. Then, according to the second embodiment of the present disclosure, when current flowing through a power semiconductor device is high, improved precision in temperature estimation processing is given priority over a reduced computation load, by determining a value acquired by multiplying a provisional junction temperature value calculated by the provisional value calculation unit 23 by a temperature compensation factor calculated by the temperature compensation factor calculation unit 22 as an estimated junction temperature value.

When a comparison result by the current comparison unit 25 indicates that a current value detected by the current detection unit 11 is equal to or greater than a current threshold value, as an estimated junction temperature value, the estimated value calculation unit 24 outputs a value acquired by multiplying a provisional junction temperature value calculated by the provisional value calculation unit 23 by a temperature compensation factor calculated by the temperature compensation factor calculation unit 22. Further, when the comparison result by the current comparison unit 25 indicates that the current value detected by the current detection unit 11 is less than the current threshold value, the estimated value calculation unit 24 outputs the provisional junction temperature value calculated by the provisional value calculation unit 23 as-is as an estimated junction temperature value.

The configuration and the operation of the temperature estimation device 1 according to the second embodiment of the present disclosure and the converter system 100 including the same other than the current detection unit 11, the estimated value calculation unit 24, and the current comparison unit 25 are similar to the configuration and the operation described with reference to FIG. 1, and therefore description thereof is omitted.

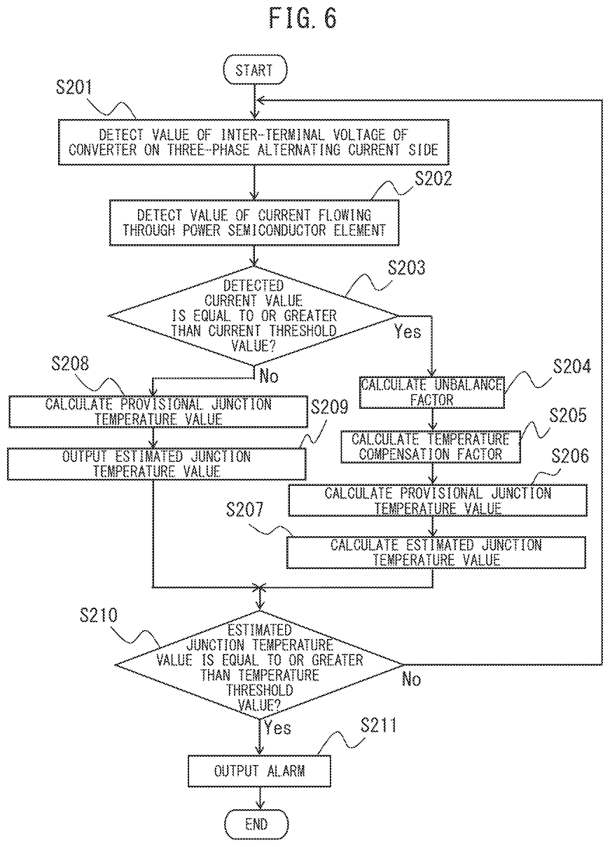

FIG. 6 is a flowchart illustrating an operation flow of the temperature estimation device according to the second embodiment of the present disclosure.

Temperature estimation processing of a power semiconductor device by the temperature estimation device 1 according to the second embodiment of the present disclosure and the converter system 100 including the same is periodically executed when the converter system 100 is connected to the three-phase power supply 4 and is actually in operation.

In step S201, a voltage detection unit 13 detects an inter-terminal voltage value of a converter 2 on the three-phase power supply 4 side. Further, while illustration is omitted in FIG. 6, an ambient temperature detection unit 14 detects the ambient temperature of a power semiconductor device, based on a signal sent from a temperature detection device 35.

In step S202, the current detection unit 11 detects a value of current flowing through a power semiconductor device provided in a three-phase bridge circuit 31 in the converter 2 (a value of current input to the converter 2).

In step S203, the current comparison unit 25 compares the current value detected by the current detection unit 11 with a predetermined current threshold value. In step S203, the processing advances to step S204 when the current value detected by the current detection unit 11 is determined to be equal to or greater than the current threshold value and advances to step S208 when the current value detected by the current detection unit 11 is determined to be less than the current threshold value.

In step S204, the unbalance factor calculation unit 21 calculates an unbalance factor of the three-phase power supply 4. The calculated unbalance factor of the three-phase power supply 4 may be an unbalance factor of voltage or an unbalance factor of current.

In step S205, the temperature compensation factor calculation unit 22 calculates a temperature compensation factor by using the unbalance factor calculated by the unbalance factor calculation unit 21.

In step S206, the provisional value calculation unit 23 calculates a provisional junction temperature value of the power semiconductor device, based on the current value detected by the current detection unit 11, the value of a resistance component of the power semiconductor device, and the ambient temperature of the power semiconductor device detected by the ambient temperature detection unit 14.

In step S207, as an estimated junction temperature value of the power semiconductor device, the estimated value calculation unit 24 outputs a value acquired by multiplying the provisional junction temperature value calculated by the provisional value calculation unit 23 by the temperature compensation factor calculated by the temperature compensation factor calculation unit 22.

On the other hand, when the current value detected by the current detection unit 11 is determined to be less than the current threshold value in step S203, the provisional value calculation unit 23 calculates a provisional junction temperature value of the power semiconductor device in step S208, based on the current value detected by the current detection unit 11, the value of the resistance component of the power semiconductor device, and the ambient temperature of the power semiconductor device detected by the ambient temperature detection unit 14.

In step S209, the estimated value calculation unit 24 outputs the provisional junction temperature value calculated by the provisional value calculation unit 23 as an estimated junction temperature value of the power semiconductor device.

The estimated junction temperature values calculated by the estimated value calculation unit 24 in step S207 and step S209 are sent to the temperature comparison unit 15. Further, for example, the estimated junction temperature value calculated by the estimated value calculation unit 24 may be displayed on a display unit (unillustrated) or be output by voice by audio equipment (unillustrated).

In step S210, the temperature comparison unit 15 compares the estimated junction temperature value calculated by the estimated value calculation unit 24 in the junction temperature estimation unit 12 with a predetermined temperature threshold value. In step S210, the processing advances to step S211 when the estimated junction temperature value is determined to be equal to or greater than the temperature threshold value and returns to step S201 when the estimated junction temperature value is determined to be less than the temperature threshold value.

In step S211, the alarm output unit 16 outputs an alarm.

The processing in steps S201 to S211 described above is periodically and repeatedly executed until an alarm is output by the alarm output unit 16 in step S211.

As described above, when the current value detected by the current detection unit 11 is determined to be less than the current threshold value in step S203, the unbalance factor calculation unit 21 and the temperature compensation factor calculation unit 22 do not operate, and a computation load of the arithmetic processing unit constituting the unbalance factor calculation unit 21 and the temperature compensation factor calculation unit 22 is reduced. Accordingly, the second embodiment of the present disclosure enables enhanced precision of an estimated junction temperature value while reducing the proportion of junction temperature estimation processing in arithmetic processing by the arithmetic processing unit (such as a CPU utilization rate), compared with the first embodiment. It should be noted that a provisional junction temperature value of the power semiconductor device may be calculated based on the forward voltage V_{f} or the collector-emitter saturation voltage V_{CE} (sat) of the power semiconductor as the resistance component of the power semiconductor device in step S206 and step S208.

Next, a temperature estimation device according to a third embodiment of the present disclosure and a converter system including the same will be described.

The third embodiment of the present disclosure switches between outputting a value acquired by multiplying a provisional junction temperature value by a temperature compensation factor as an estimated junction temperature value and outputting the provisional junction temperature value as-is as an estimated junction temperature value, based on the magnitude of current flowing through a power semiconductor device and an unbalance factor of a three-phase power supply.

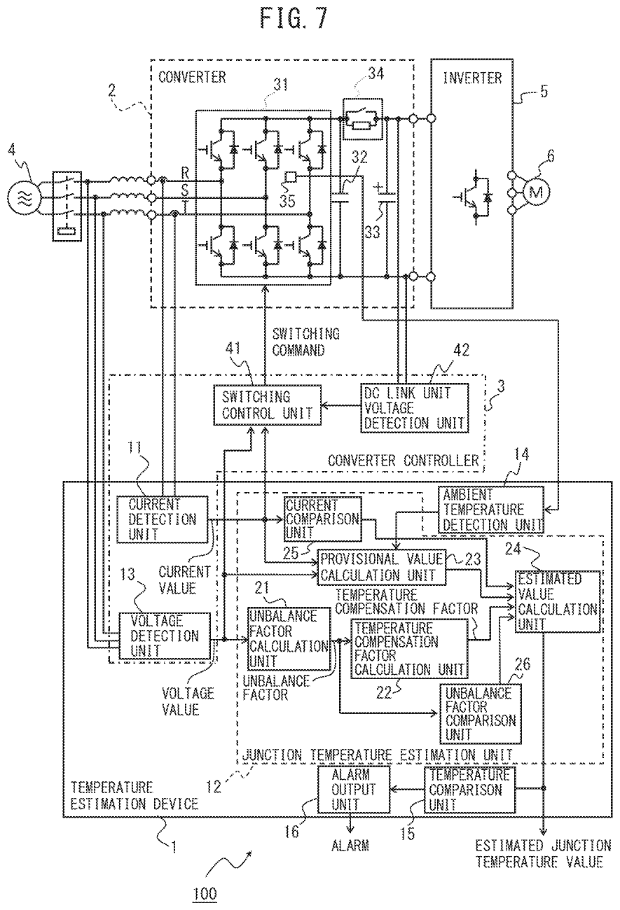

FIG. 7 is a diagram illustrating a temperature estimation device according to the third embodiment of the present disclosure and a converter system including the same.

A temperature estimation device 1 according to the third embodiment of the present disclosure is acquired by adding a current comparison unit 25 and an unbalance factor comparison unit 26 to the junction temperature estimation unit 12 in the temperature estimation device 1 according to the first embodiment illustrated in FIG. 1 or FIG. 2. In other words, a junction temperature estimation unit 12 further includes the current comparison unit 25 and the unbalance factor comparison unit 26.

A current value detected by a current detection unit 11 is also sent to the current comparison unit 25 in addition to a provisional value calculation unit 23 in the junction temperature estimation unit 12 and a switching control unit 41 in a converter controller 3.

The current comparison unit 25 compares the current value detected by the current detection unit 11 with a predetermined current threshold value. For example, the current threshold value is set to 60% of a rated current of a power semiconductor device, but the numerical value mentioned here is strictly an example, and the current threshold value may take on a different numerical value. The comparison result by the current comparison unit 25 is sent to an estimated value calculation unit 24.

An unbalance factor calculated by an unbalance factor calculation unit 21 is also sent to the unbalance factor comparison unit 26 in addition to the temperature compensation factor calculation unit 22.

The unbalance factor comparison unit 26 compares an unbalance factor calculated by the unbalance factor calculation unit 21 with a predetermined unbalance factor threshold value. The comparison result by the unbalance factor comparison unit 26 is sent to the estimated value calculation unit 24. For example, the unbalance factor threshold value is set to 2%, but the numerical value mentioned here is strictly an example, and the unbalance factor threshold value may take on a different numerical value. Further, for example, the unbalance factor threshold value may be set after finding a relationship with an application environment of a converter system 100 and existence of an alarm output by an alarm output unit 16, or the like in advance by operating the converter system 100 experimentally or through actual operation, or by a computer simulation. The set unbalance factor threshold value is stored in a storage unit (unillustrated). It should be noted that by configuring the storage unit (unillustrated) storing the unbalance factor threshold value rewritable by external equipment, the unbalance factor threshold value can be changed to a suitable value as needed even after being temporarily set.

When current flowing through a power semiconductor device is low, an effect of an unbalance factor of a three-phase power supply 4 is small, and therefore a provisional junction temperature value calculated by the provisional value calculation unit 23 is considered close to the true value. Then, according to the third embodiment of the present disclosure, when current flowing through a power semiconductor device is low, a computation load of an arithmetic processing unit constituting the unbalance factor calculation unit 21 and a temperature compensation factor calculation unit 22 is reduced by not operating the unbalance factor calculation unit 21 and the temperature compensation factor calculation unit 22 and determining the provisional junction temperature value as-is as an estimated junction temperature value. Further, even when current flowing through a power semiconductor device is high, an effect of an unbalance factor of the three-phase power supply 4 is small when the unbalance factor of the three-phase power supply 4 is low, and therefore a provisional junction temperature value calculated by the provisional value calculation unit 23 is considered close to the true value. Then, according to the third embodiment of the present disclosure, when current flowing through a power semiconductor device is low and an unbalance factor of the three-phase power supply 4 is small, a computation load of the arithmetic processing unit constituting the temperature compensation factor calculation unit 22 is reduced by not operating the temperature compensation factor calculation unit 22 and determining the provisional junction temperature value as-is as an estimated junction temperature value. Further, when current flowing through a power semiconductor device is high and an unbalance factor of the three-phase power supply 4 is high, an effect of the unbalance factor of the three-phase power supply 4 is large, and therefore a provisional junction temperature value calculated by the provisional value calculation unit 23 is considered to greatly deviate from the true value. Then, according to the third embodiment of the present disclosure, when current flowing through a power semiconductor device is high, improved precision in temperature estimation processing is given priority over a reduced computation load by determining a value acquired by multiplying the provisional junction temperature value calculated by the provisional value calculation unit 23 by a temperature compensation factor calculated by the temperature compensation factor calculation unit 22 as an estimated junction temperature value.

When a comparison result by the current comparison unit 25 indicates that a current value detected by the current detection unit 11 is equal to or greater than the current threshold value and a comparison result by the unbalance factor comparison unit 26 indicates that an unbalance factor calculated by the unbalance factor calculation unit is equal to or greater than the unbalance factor threshold value, as an estimated junction temperature value, the estimated value calculation unit 24 outputs a value acquired by multiplying a provisional junction temperature value calculated by the provisional value calculation unit 23 by a temperature compensation factor calculated by the temperature compensation factor calculation unit 22. Further, when the comparison result by the current comparison unit 25 indicates that the current value detected by the current detection unit 11 is less than the current threshold value, the estimated value calculation unit 24 outputs the provisional junction temperature value calculated by the provisional value calculation unit 23 as-is as an estimated junction temperature value. Further, when the comparison result by the current comparison unit 25 indicates that the current value detected by the current detection unit 11 is equal to or greater than the current threshold value and the unbalance factor calculated by the unbalance factor comparison unit 26 is less than the unbalance factor threshold value, the estimated value calculation unit 24 outputs the provisional junction temperature value calculated by the provisional value calculation unit 23 as-is as an estimated junction temperature value.

The configuration and the operation of the temperature estimation device 1 according to the third embodiment of the present disclosure and the converter system 100 including the same other than the current detection unit 11, the unbalance factor calculation unit 21, the estimated value calculation unit 24, the current comparison unit 25, and the unbalance factor comparison unit 26 are similar to the configuration and the operation described with reference to FIG. 1, and therefore description thereof is omitted.

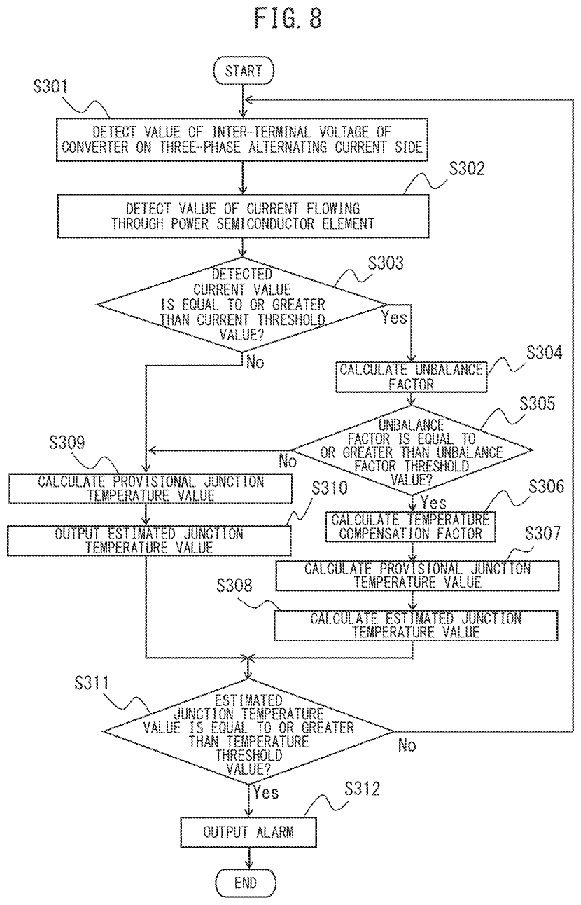

FIG. 8 is a flowchart illustrating an operation flow of the temperature estimation device according to the third embodiment of the present disclosure.

Temperature estimation processing of a power semiconductor device by the temperature estimation device 1 according to the third embodiment of the present disclosure and the converter system 100 including the same is periodically executed when the converter system 100 is connected to the three-phase power supply 4 and is actually in operation.

In step S301, a voltage detection unit 13 detects a value of the inter-terminal voltage of the converter 2 on the three-phase power supply 4 side. Further, while illustration is omitted in FIG. 8, an ambient temperature detection unit 14 detects the ambient temperature of a power semiconductor device, based on a signal sent from a temperature detection device 35.

In step S302, the current detection unit 11 detects a value of current flowing through a power semiconductor device provided in a three-phase bridge circuit 31 in a converter 2 (a value of current input to the converter 2).

In step S303, the current comparison unit 25 compares the current value detected by the current detection unit 11 with a predetermined current threshold value. In step S303, the processing advances to step S304 when the current value detected by the current detection unit 11 is determined to be equal to or greater than the current threshold value and advances to step S309 when the current value detected by the current detection unit 11 is determined to be less than the current threshold value.

In step S304, the unbalance factor calculation unit 21 calculates an unbalance factor of the three-phase power supply 4. The calculated unbalance factor of the three-phase power supply 4 may be an unbalance factor of voltage or an unbalance factor of current.

In step S305, the unbalance factor comparison unit 26 compares the unbalance factor calculated by the unbalance factor calculation unit 21 with a predetermined unbalance factor threshold value. In step S305, the processing advances to step S306 when the unbalance factor calculated by the unbalance factor calculation unit 21 is determined to be equal to or greater than the unbalance factor threshold value and advances to step S309 when the unbalance factor calculated by the unbalance factor calculation unit 21 is determined to be less than the unbalance factor threshold value.

In step S306, the temperature compensation factor calculation unit 22 calculates a temperature compensation factor by using the unbalance factor calculated by the unbalance factor calculation unit 21.

In step S307, the provisional value calculation unit 23 calculates a provisional junction temperature value of the power semiconductor device, based on the current value detected by the current detection unit 11, the value of a resistance component of the power semiconductor device, and the ambient temperature of the power semiconductor device detected by the ambient temperature detection unit 14.

In step S308, as an estimated junction temperature value of the power semiconductor device, the estimated value calculation unit 24 outputs a value acquired by multiplying the provisional junction temperature value calculated by the provisional value calculation unit 23 by the temperature compensation factor calculated by the temperature compensation factor calculation unit 22.

On the other hand, when the current value detected by the current detection unit 11 is determined to be less than the current threshold value in step S303 or the unbalance factor calculated by the unbalance factor calculation unit 21 is determined to be less than the unbalance factor threshold value in step S305, the provisional value calculation unit 23 calculates a provisional junction temperature value of the power semiconductor device in step S309, based on the current value detected by the current detection unit 11, the inter-terminal voltage value detected by the voltage detection unit 13, and the ambient temperature of the power semiconductor device detected by the ambient temperature detection unit 14.

In step S310, the estimated value calculation unit 24 outputs the provisional junction temperature value calculated by the provisional value calculation unit 23 as an estimated junction temperature value of the power semiconductor device.

The estimated junction temperature values calculated by the estimated value calculation unit 24 in step S308 and step S310 are sent to a temperature comparison unit 15. Further, for example, the estimated junction temperature value calculated by the estimated value calculation unit 24 may be displayed on a display unit (unillustrated) or be output by voice by audio equipment (unillustrated).

In step S311, the temperature comparison unit 15 compares the estimated junction temperature value calculated by the estimated value calculation unit 24 in the junction temperature estimation unit 12 with a predetermined temperature threshold value. In step S311, the processing advances to step S312 when the estimated junction temperature value is determined to be equal to or greater than the temperature threshold value and returns to step S301 when the estimated junction temperature value is determined to be less than the temperature threshold value.

In step S312, the alarm output unit 16 outputs an alarm.

The processing in steps S301 to S312 described above is periodically and repeatedly executed until an alarm is output by the alarm output unit 16 in step S311.

As described above, when the current value detected by the current detection unit 11 is determined to be less than the current threshold value in step S303, the unbalance factor calculation unit 21 and the temperature compensation factor calculation unit 22 do not operate, and a computation load of an arithmetic processing unit constituting the unbalance factor calculation unit 21 and the temperature compensation factor calculation unit 22 is reduced. Accordingly, the third embodiment of the present disclosure enables enhanced precision of an estimated junction temperature value while reducing the proportion of junction temperature estimation processing in arithmetic processing by the arithmetic processing unit (such as a CPU utilization rate), compared with the first embodiment. Further, when the unbalance factor calculated by the unbalance factor calculation unit 21 is determined to be less than the unbalance factor threshold value in step S305, the temperature compensation factor calculation unit 22 does not operate, and a computation load of the arithmetic processing unit constituting the temperature compensation factor calculation unit 22 is reduced. Accordingly, the third embodiment of the present disclosure enables enhanced precision of an estimated junction temperature value while reducing the proportion of the junction temperature estimation processing in the arithmetic processing by the arithmetic processing unit (such as a CPU utilization rate), compared with the second embodiment.

Next, a temperature estimation device according to the fourth embodiment of the present disclosure and a converter system including the same will be described.

The fourth embodiment of the present disclosure detects a value of current flowing through a power semiconductor device for each phase of a converter and calculates an estimated junction temperature value of a power semiconductor device through which current with the maximum value flows.

A connection relation between components in a temperature estimation device according to the fourth embodiment of the present disclosure and converter system including the same is the same as the connection relation between components in the temperature estimation device according to the first embodiment and the converter system including the same that are illustrated in FIG. 1. However, operation of each of a current detection unit 11, and a provisional value calculation unit 23 and an estimated value calculation unit 24 in a junction temperature estimation unit 12 according to the fourth embodiment of the present disclosure differs from the operation of each of the current detection unit 11, and the provisional value calculation unit 23 and the estimated value calculation unit 24 in the junction temperature estimation unit 12 according to the first embodiment. Specifics are as follows.

The current detection unit 11 detects a value of current flowing through a power semiconductor device in a three-phase bridge circuit 31 in a converter 2 for each phase of the converter. In other words, the current detection unit 11 detects a value of current flowing through a power semiconductor device in an R-phase in the three-phase bridge circuit 31, a value of current flowing through a power semiconductor device in an S-phase, and a value of current flowing through a power semiconductor device in a T-phase. The current value of each phase detected by the current detection unit 11 is sent to the provisional value calculation unit 23.

Based on a provisional junction temperature value calculated based on at least the maximum value out of the current values in the respective phases detected by the current detection unit 11 and an unbalance factor, the junction temperature estimation unit 12 calculates an estimated junction temperature value of a power semiconductor device through which the current with the maximum value flows. More detailed description of operation of the provisional value calculation unit 23 and the estimated value calculation unit 24 in the junction temperature estimation unit 12 is as follows.

The provisional value calculation unit 23 determines the maximum current value out of the currents in the respective phases detected by the current detection unit 11 and calculates a provisional junction temperature value of a power semiconductor device through which the current with the maximum value flows, based on the maximum current value, an inter-terminal voltage value detected by a voltage detection unit 13, and the ambient temperature of the power semiconductor device detected by an ambient temperature detection unit 14.

As an estimated junction temperature value of the power semiconductor device through which current with the maximum value flows, the estimated value calculation unit 24 outputs a value acquired by multiplying the provisional junction temperature value of the power semiconductor device by a temperature compensation factor calculated by a temperature compensation factor calculation unit 22. In this connection, the provisional junction temperature value of the power semiconductor device through which current with the maximum value flows is calculated by the provisional value calculation unit 23.

The configuration and the operation of the temperature estimation device 1 according to the fourth embodiment of the present disclosure and the converter system 100 including the same other than the current detection unit 11, and the provisional value calculation unit 23 and the estimated value calculation unit 24 in the junction temperature estimation unit 12 are similar to the configuration and the operation described with reference to FIG. 1, and therefore description thereof is omitted.

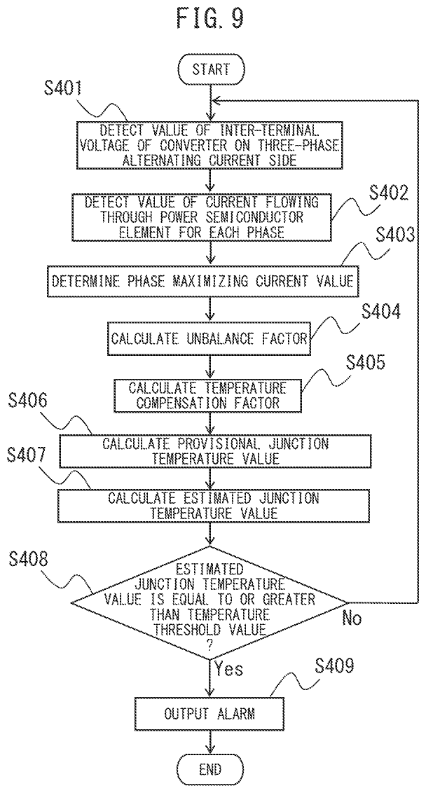

FIG. 9 is a flowchart illustrating an operation flow of the temperature estimation device according to the fourth embodiment of the present disclosure.

Temperature estimation processing of a power semiconductor device by the temperature estimation device 1 according to the fourth embodiment of the present disclosure and the converter system 100 including the same is periodically executed when the converter system 100 is connected to the three-phase power supply 4 and is actually in operation.

In step S401, the voltage detection unit 13 detects a value of the inter-terminal voltage of the converter 2 on the three-phase power supply 4 side. Further, while illustration is omitted in FIG. 9, the ambient temperature detection unit 14 detects the ambient temperature of the power semiconductor device, based on a signal sent from a temperature detection device 35.

In step S402, the current detection unit 11 detects a value of current flowing through a power semiconductor device in the three-phase bridge circuit 31 in the converter 2 (a value of current input to the converter 2 in each phase) for each phase of the converter. The current value in each phase detected by the current detection unit 11 is sent to the provisional value calculation unit 23.

In step S403, the provisional value calculation unit 23 determines the maximum current value out of the currents in the respective phases detected by the current detection unit 11.

In step S404, an unbalance factor calculation unit 21 calculates an unbalance factor of the three-phase power supply 4. The calculated unbalance factor of the three-phase power supply 4 may be an unbalance factor of voltage or an unbalance factor of current.

In step S405, the temperature compensation factor calculation unit 22 calculates a temperature compensation factor by using the unbalance factor calculated by the unbalance factor calculation unit 21.

It should be noted that the processing in step S403 and the processing in steps S404 and S405 may be executed in reverse order.

In step S406, the provisional value calculation unit 23 calculates a provisional junction temperature value of a power semiconductor device through which current with the maximum value flows, based on the maximum current value determined in step S403, the value of a resistance component of the power semiconductor device, and the ambient temperature of the power semiconductor device detected by the ambient temperature detection unit 14.

In step S407, as an estimated junction temperature value of the power semiconductor device through which current with the maximum value flows, the estimated value calculation unit 24 outputs a value acquired by multiplying the provisional junction temperature value of the power semiconductor device by the temperature compensation factor calculated by the temperature compensation factor calculation unit 22. In this connection, the provisional junction temperature value of the power semiconductor device through which current with the maximum value flows is calculated by the provisional value calculation unit 23. The estimated junction temperature value calculated by the estimated value calculation unit 24 in step S407 is sent to a temperature comparison unit 15. Further, for example, the estimated junction temperature value calculated by the estimated value calculation unit 24 may be displayed on a display unit (unillustrated) or be output by voice by audio equipment (unillustrated).

In step S408, the temperature comparison unit 15 compares an estimated junction temperature value calculated by the estimated value calculation unit 24 in the junction temperature estimation unit 12 with a predetermined temperature threshold value. In step S408, the processing advances to step S409 when the estimated junction temperature value is determined to be equal to or greater than the temperature threshold value and returns to step S401 when the estimated junction temperature value is determined to be less than the temperature threshold value.

In step S409, an alarm output unit 16 outputs an alarm.

The processing in steps S401 to S409 described above is periodically and repeatedly executed until an alarm is output by the alarm output unit 16 in step S408.

A power semiconductor device provided in a phase in which the maximum current flows in the three-phase bridge circuit 31 generates the highest heat and is highly likely to be damaged and have a shortened life. According to the fourth embodiment of the present disclosure, alarm output is determined based on an estimated junction temperature value of a power semiconductor device through which current with the maximum value flows, and therefore the power semiconductor device can be more reliably protected from overheating, and the possibility of damage to and a shortened life of the power semiconductor device can be reduced.

An arithmetic processing unit (processor) is provided in the temperature estimation device 1 according to the first to fourth embodiments. The arithmetic processing unit includes the current detection unit 11, the junction temperature estimation unit 12, the voltage detection unit 13, the ambient temperature detection unit 14, the temperature comparison unit 15, and the alarm output unit 16 that are described above. For example, each unit included in the arithmetic processing unit is a function module provided by a computer program executed on the processor. For example, when the current detection unit 11, the junction temperature estimation unit 12, the voltage detection unit 13, the ambient temperature detection unit 14, the temperature comparison unit 15, and the alarm output unit 16 are constructed in a computer program format, the function of each unit can be provided by operating the arithmetic processing unit in accordance with the computer program. The computer program for executing processing by each of the current detection unit 11, the junction temperature estimation unit 12, the voltage detection unit 13, the ambient temperature detection unit 14, the temperature comparison unit 15, and the alarm output unit 16 may be provided in a form of being recorded on a computer-readable recording medium such as a semiconductor memory, a magnetic recording medium, or an optical recording medium. Alternatively, the current detection unit 11, the junction temperature estimation unit 12, the voltage detection unit 13, the ambient temperature detection unit 14, the temperature comparison unit 15, and the alarm output unit 16 may be provided as a semiconductor integrated circuit in which the computer program providing the function of each unit is written.

### REFERENCE SIGNS LIST

1 Temperature estimation device
2 Converter
3 Converter controller
4 Three-phase power supply
5 Inverter
6 Motor
11 Current detection unit
12 Junction temperature estimation unit
13 Voltage detection unit
14 Ambient temperature detection unit
15 Temperature comparison unit
16 Alarm output unit
21 Unbalance factor calculation unit
22 Temperature compensation factor calculation unit
23 Provisional value calculation unit
24 Estimated value calculation unit
25 Current comparison unit
26 Unbalance factor comparison unit
31 Three-phase bridge circuit
32 Smoothing capacitor
33 DC link capacitor
34 Pre-charging circuit
35 Temperature detection device
41 Switching control unit
42 DC link unit voltage detection unit

1. A temperature estimation device configured to calculate an estimated junction temperature value of a power semiconductor device provided in a converter configured to perform power conversion between alternating-current power on a three-phase power supply side and direct-current power on a direct current side, the temperature estimation device comprising:
a current detection unit configured to detect a value of current flowing through the power semiconductor device; and
a junction temperature estimation unit configured to calculate an estimated junction temperature value of the power semiconductor device, based on a provisional junction temperature value calculated based on at least a value of the current detected by the current detection unit, and an unbalance factor of the three-phase power supply connected to the converter.

2. The temperature estimation device according to claim 1, wherein
the junction temperature estimation unit includes:
an unbalance factor calculation unit configured to calculate the unbalance factor;
a temperature compensation factor calculation unit configured to calculate a temperature compensation factor, based on the unbalance factor;
a provisional value calculation unit configured to calculate the provisional junction temperature value; and
an estimated value calculation unit configured to output a value acquired by multiplying the provisional junction temperature value by the temperature compensation factor as the estimated junction temperature value.

3. The temperature estimation device according to claim 2, wherein the provisional value calculation unit calculates the provisional junction temperature value, based on at least a value of the current detected by the current detection unit and a value of a resistance component of the power semiconductor device.

4. The temperature estimation device according to claim 2, further comprising an ambient temperature detection unit configured to detect ambient temperature of the power semiconductor device,
wherein the provisional value calculation unit calculates the provisional junction temperature value, based on at least a value of the current detected by the current detection unit and the ambient temperature.

5. The temperature estimation device according to claim 2, further comprising a voltage detection unit configured to detect a value of inter-terminal voltage of the converter on a three-phase power supply side,
wherein the unbalance factor calculation unit calculates the unbalance factor, based on a value of the inter-terminal voltage detected by the voltage detection unit.

6. The temperature estimation device according to claim 2, wherein the unbalance factor calculation unit calculates the unbalance factor, based on a value of the current detected by the current detection unit.

7. The temperature estimation device according to claim 2, wherein
the junction temperature estimation unit further includes a current comparison unit configured to compare a value of the current detected by the current detection unit with a predetermined current threshold value, and
the estimated value calculation unit outputs a value acquired by multiplying the provisional junction temperature value by the temperature compensation factor as the estimated junction temperature value when a value of the current detected by the current detection unit is equal to or greater than the current threshold value and outputs the provisional junction temperature value as the estimated junction temperature value when a value of the current detected by the current detection unit is less than the current threshold value.

8. The temperature estimation device according to claim 2, wherein
the junction temperature estimation unit further includes a current comparison unit configured to compare a value of the current detected by the current detection unit with a predetermined current threshold value and an unbalance factor current comparison unit configured to compare the unbalance factor with a predetermined unbalance factor threshold value, and
the estimated value calculation unit outputs a value acquired by multiplying the provisional junction temperature value by the temperature compensation factor as the estimated junction temperature value when a value of the current detected by the current detection unit is equal to or greater than the current threshold value and the unbalance factor is equal to or greater than the unbalance factor threshold value and outputs the provisional junction temperature value as the estimated junction temperature value when a value of the current detected by the current detection unit is less than the current threshold value or when a value of the current detected by the current detection unit is equal to or greater than the current threshold value and the unbalance factor is less than the unbalance factor threshold value.

9. The temperature estimation device according to claim 1, wherein
the current detection unit detects a value of current flowing through the power semiconductor device for each of one or more phases of the converter, and
the junction temperature estimation unit calculates an estimated junction temperature value of the power semiconductor device through which current with a maximum value flows, based on a provisional junction temperature value calculated based on at least the maximum value out of values of the current in respective phases detected by the current detection unit, and the unbalance factor.

10. The temperature estimation device according to claim 1, further comprising:
a temperature comparison unit configured to compare the estimated junction temperature value calculated by the junction temperature estimation unit with a predetermined temperature threshold value; and
an alarm output unit configured to output an alarm when the estimated junction temperature value is equal to or greater than the temperature threshold value.

11. A converter system comprising:
the temperature estimation device according to claim 1; and
the converter being provided with the power semiconductor device and configured to perform power conversion between alternating-current power on a three-phase power supply side and direct-current power on a direct current side by on-off operation of the power semiconductor device,
wherein the junction temperature estimation unit calculates an estimated junction temperature value of the power semiconductor device.
